(19) United States
(12) Patent Application Publication
(10) Pub. No.: US 2006/0097211 A1
(43) Pub. Date: May 11, 2006

(54) Air intake control device for a paint gun

(76) Inventors: Michael Steven Spurlock, South Mobile, AL (US); Hsin-Cheng Yeh, Yung Kung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/984,904

(22) Filed: Nov. 10, 2004

(51) Int. Cl. F16K 31/02

(52) U.S. Cl. 251/129.15

(57) ABSTRACT

An air intake control device for a paint gun utilizes an electromagnet to control air current. The electromagnet comprises a spindle having a circular trough thereon. A diverter bushing is formed at one end of the electromagnet. The diverter bushing comprises a transverse through hole corresponding to the spindle, a first air hole, a second air hole and an air outlet longitudinally interconnected with the transverse through hole. The transverse through hole receives a spring therein to divert air current when the spindle is activated.

### BACKGROUND OF THE INVENTION

1. Field of the Invention

This invention relates to an air intake control device for a paint gun, and more particularly to a paint gun having an electromagnet.

2. Description of the Prior Art

A survival game has been becoming a popular way for young people to experience partial military life and also for the military to train their soldiers.

In order to provide a safe and exciting game, a paint gun is the most appropriate tool to use.

The first stage paint gun uses compressed air to fire a paint ball. This design can only shoot in a single shot, which is boring and out of date to the current technology. Thus, a paint gun with a continuous shooting is derived, as shown in FIG. 5, which comprises a gun body A, a hammer B, a piston rod C, an elastic element D, a handle E, and an electromagnetic valve F. The gun body A has a hollow body to receive the hammer B at the front section. An air intake Al is formed at the rear section of the gun body A. The piston rod C is placed in the gun body A in front of the air intake A1. The elastic element D is placed between the hammer B and the piston rod C. The electromagnetic valve F is secured in the handle E. The electromagnetic valve F is interconnected with the air intake Al of the gun body A through a pipe. The electromagnetic valve F controls air current through the air intake A1 to push the piston rod C to urge the elastic element D forward and to strike the hammer B. The piston rod C will then return to its original position by the elastic element D. Thus, the piston rod C will continuously be urged by the elastic element D to strike the hammer B again in a continuous status.

The prior design utilizes an electromagnetic valve to control air current. The mini-sized electromagnetic valve is costly, which increases the cost of manufacture.

### SUMMARY OF THE INVENTION

It is the primary object of the present invention to provide an air intake control device for a paint gun, which design is simple and lowers the cost of manufacture.

It is another object of the present invention to provide an air intake control device for a paint gun, which is easy in maintenance.

It is a further object of the present invention to provide an air intake control device for a paint gun, which is easy to operate.

### BRIEF DESCRIPTION OF THE DRAWINGS

FIG. 1 is a cross-sectional view of the present invention;

FIG. 2 is a cross-sectional view of an electromagnet of the present invention;

FIG. 3 is a view similar to FIG. 1 showing the bullet in a triggered status;

FIG. 4 is a view similar to FIG. 2 showing the electromagnet in an activated status, and

FIG. 5 is a cross-sectional view of a prior art.

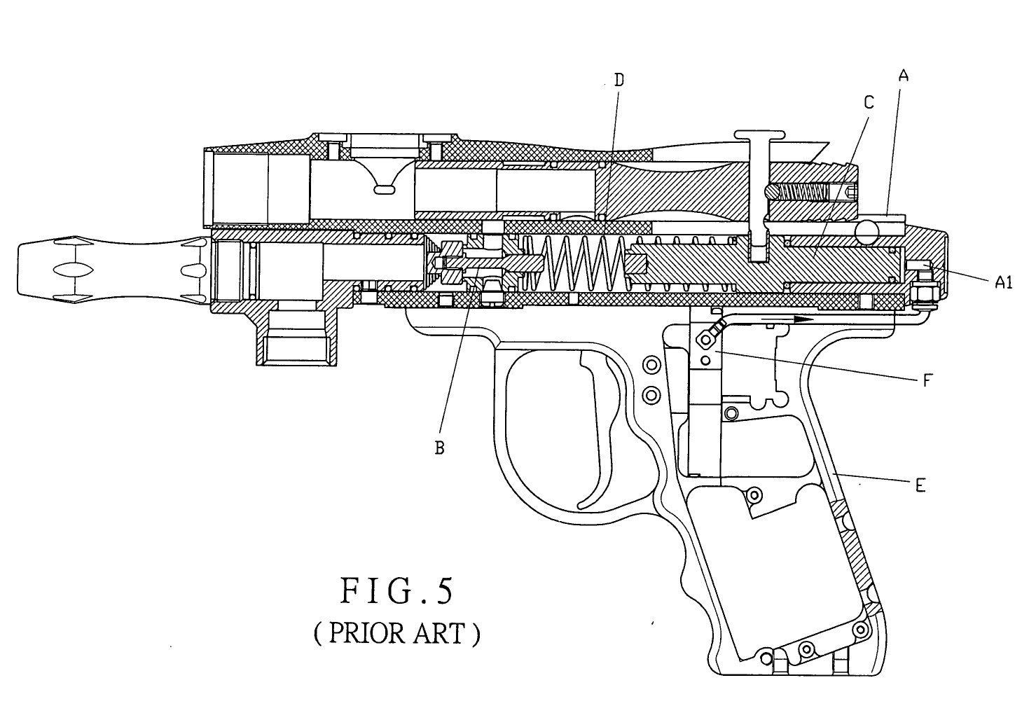

### DETAILED DESCRIPTION OF THE PREFERRED EMBODIMENT

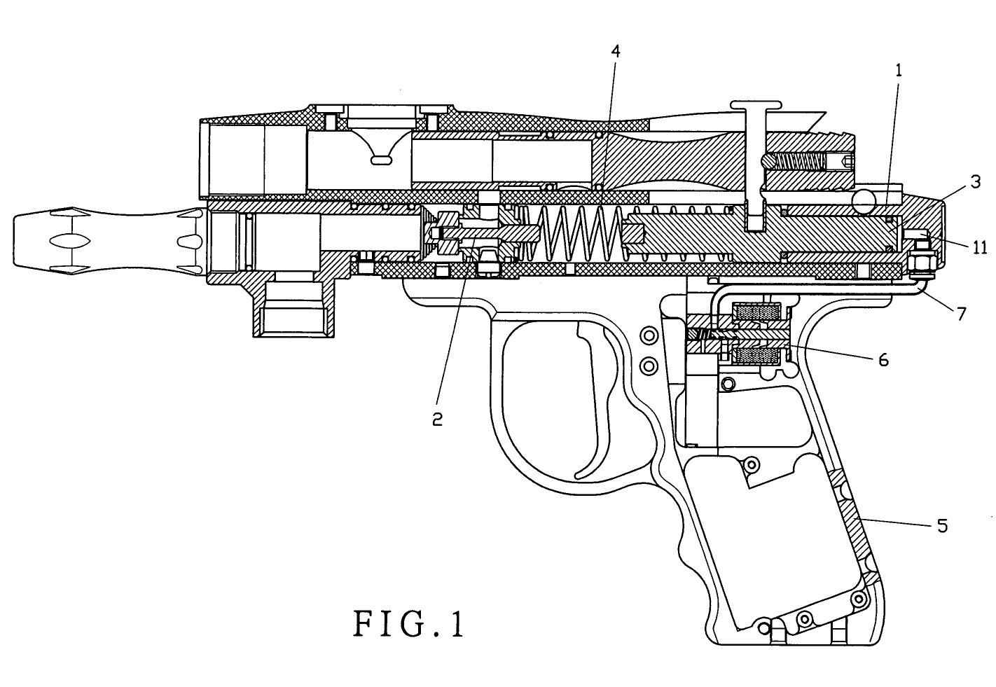

As shown in FIGS. 1˜2, the present invention comprises a body 1, a hammer 2, a piston rod 3, an elastic element 4, a handle 5 and an electromagnet 6.

The body 1 comprises a front section and a rear section. The front section receives the hammer 2 therein, and the rear section comprises an air intake 11 and is connected to the handle 5.

The piston rod 3 is located in the body 1 in front of the air intake 11. The elastic element 4 is placed between the hammer 2 and the piston rod 3. The handle 5 accommodates the electromagnet 6 therein. The electromagnet 6 controls air current into the body 1 through the air intake 11. The air current pushes the piston rod 3 and the elastic element 4 to move forward and to strike the hammer 2. The elastic element 4 will then urge the piston rod 3 back to its original position.

The electromagnet 6 comprises a spindle 61 along the axle therein. The spindle 61 comprises a circular trough 611 at one end and is sealed with several sealing rings 612. A diverter bushing 62 is formed at one end of the electromagnet 6 and comprises a transverse through hole 621 corresponding to the spindle 61, a first air hole 622, a second air hole 623 and an air outlet 624 longitudinally interconnected with the through hole 621. The through hole 621 accommodates a block 625 and a spring 626 therein.

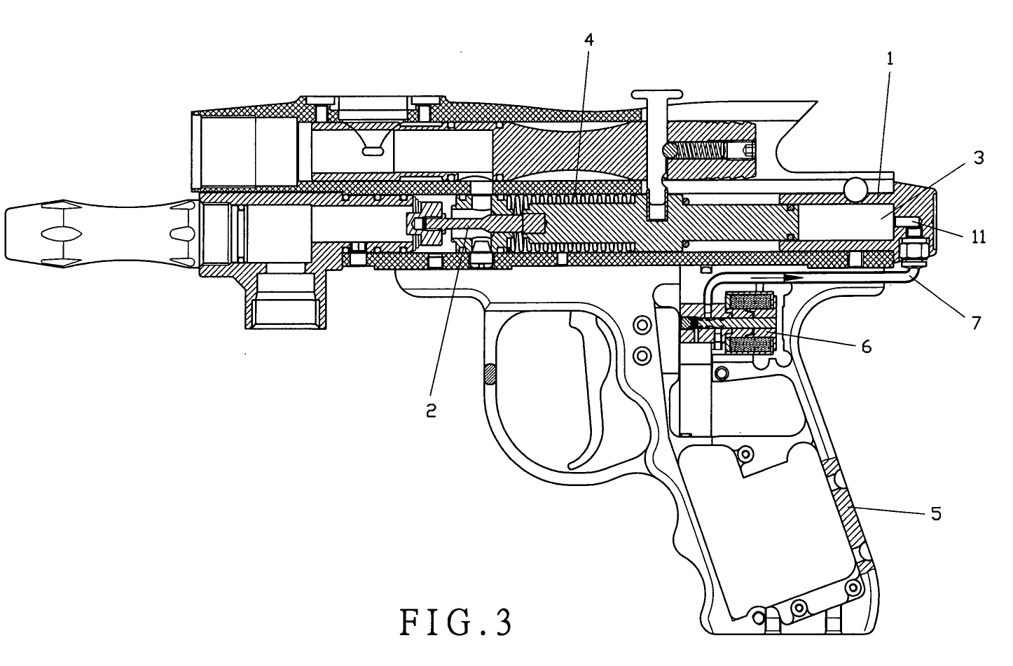

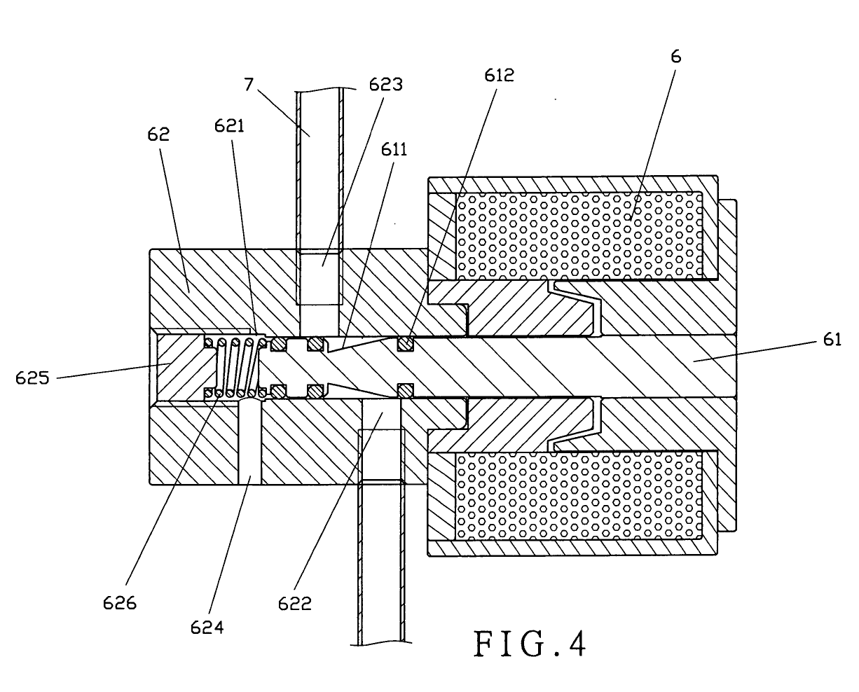

To operate the paint gun of the present invention, as shown in FIGS. 3 and 4, pulling the trigger activates the electromagnet 6 which extends the spindle 61 towards the diverter bushing 62 with the far end of the spindle 61 engaging with the spring 626. The circular trough 611 corresponds to the first air hole 622 and the second air hole 623 while the air outlet 624 is blocked by the far end of the spindle 61. The first air hole 622 and the second air hole 623 are not interconnected with each other. Air current enters through the first air hole 622 and flows through the circular trough 611 to the second air hole 623 and then goes through an air pipe 7. The air pipe 7 interconnects with the air intake 11 to push the piston rod 3 and the elastic element 4 forward to strike the hammer 2.

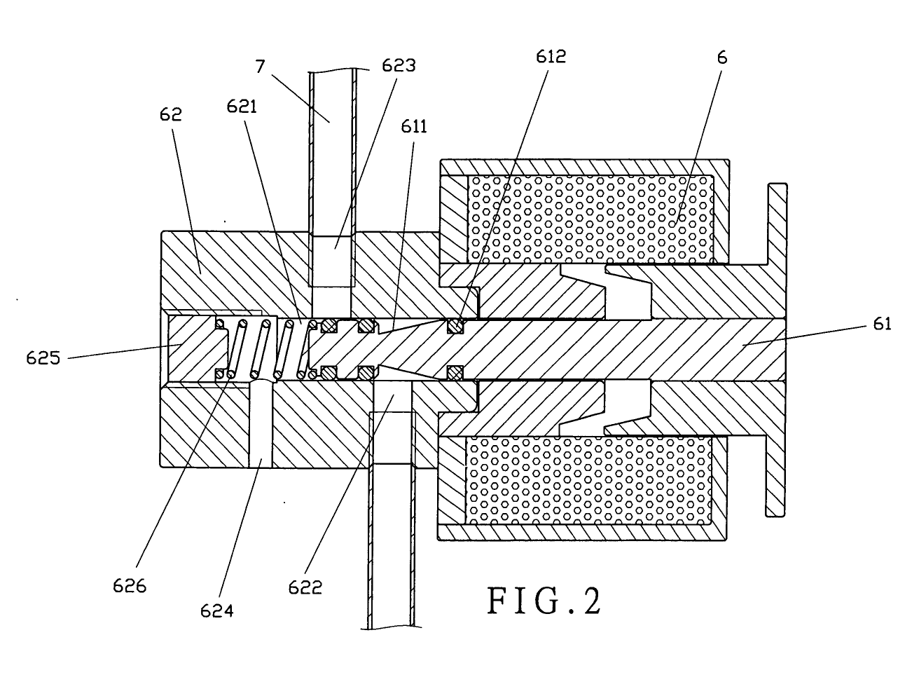

When the electromagnet 6 is deactivated, as shown in FIGS. 1 and 2, the spindle 61 is urged by the spring 626 to return to its original position. The circular trough 611 detaches from the second air hole 623, which stops the air from flowing into the body 1 through either first air hole 622 or the second air hole 623. Thus the piston rod 3 is urged by the elastic element 4 to retreat to its original position, and the air in the body 1 will be expelled through the air outlet 624. In this case, the piston rod 3 and the elastic element 4 constantly come and forth within the body 1 to shoot bullets in a constant manner.

What is claimed is:

1. An air intake control device for a paint gun comprising an electromagnet in a handle to control air current, and characterized in that:
said electromagnet comprising a spindle having a circular trough thereon, a diverter bushing being formed at one end of said electromagnet, said diverter bushing having a transverse through hole corresponding to said spindle, a first air hole, a second air hole and an air outlet longitudinally interconnected with said transverse through hole, said transverse through hole accommodating a spring relative to one end of said spindle to facilitate movement of said spindle to guide air current.
